(19) United States
(12) Patent Application Publication
(10) Pub. No.: US 2020/0186486 A1
(43) Pub. Date: Jun. 11, 2020

(54) SYSTEM AND METHOD FOR FACILITATING CONTEXTUAL INFORMATION ON BUSINESS CONTACTS

(71) Applicant: Kenny Thomas, Kochi (IN)

(72) Inventor: Kenny Thomas, Kochi (IN)

(21) Appl. No.: 16/341,445

(22) PCT Filed: Dec. 30, 2017
(86) PCT No.: PCT/IB2017/058550

§ 371 Date: Apr. 12, 2019

(30) Foreign Application Priority Data
Mar. 31, 2017 (IN) 201741011889

(51) Int. Cl. H04L 12/58; H04L 29/08

(52) U.S. Cl. CPC H04L 51/28; H04L 67/306; H04L 51/043

(57) ABSTRACT

A plurality of computing devices, each comprises a user terminal configured to create a profile of the user with a business attribute using a unique identity. The user terminal has an interaction unit to track and record at least one user interactions between the user and the contact or non-contact of computing device, using the business attribute. A server is configured to store the profile of each user along with the business attributes, match and retrieve the profile of each user corresponding to the contact data and/or non-contact data in the computing device, cluster the profile of each user to form a contextual information based on the business attribute and at least one user interaction, and store the contextual information of the user in the server. The computing device retrieves the contextual information of the contacts and non-contacts from the server and displays in the user terminal.

### TECHNICAL FIELD

The present disclosure relates to a contextual network system and method to assess each constituent of the network in a professional work environment. In particular, the present system terminal provides an operation and method suited to providing context of the professional expertise of users (constituents) using a mobile or computing device in the network.

### BACKGROUND ART

When the network involves numerous activities, voluminous information and multiple participants/users, then the network becomes difficult for users to visualize, assimilate, initiate and engage with other participants in and out of their network. In this reference an ad-hoc system has not helped users neither has any been developed to assess and process, an understanding of the individual's interactions with multiple participants. More particularly, a network interaction system should provide real time information to users about stakeholders, partners, prospects and peers at work. If such systems have been developed they are often closed systems in a closed network with varying degrees of success and limited in including external participants and stakeholders. This problem is particularly acute in situations where the processes are highly information-intensive, involve multiple data sources and involve external participants.

As such, it is often a challenging proposition for an individual to simply get context about their own network, let alone derive meaningful interpretation from the network or correlate additional data to arrive at an insight about their network at work or in any formal/informal network.

Users are faced with the problem of managing information intensive systems that help them in identifying partners, prospects, customers, suppliers or new employees. Such an assessment is particularly a difficult process for individuals to manage or even arrive at, because it requires multiple kinds of data at various interactions points and inputs from various different systems, as all data points are not on one system, and finally in order to be good in the assessment there has to be very few errors in such an assessment.

Each user would have had variegated interactions in multiple environments and with multiple participants/users, in addition there is no single system network that can record all interactions, as some would involve interactions with participants not in the system while some interactions can be within the system. A system network being one that is operation in a company where another system may be in operation in another company, so interactions between two or more individuals in multiple companies will have no processes that can assess interactions in disparate systems. With the lack of such a system of assessments by any individuals about their fellow network, users in variegated systems, the process will often be unable to correctly assess network participants due to an incomplete set of data. Even if the data set could be collated, to effectively and efficiently conduct such an assessment is laborious, notwithstanding that the assessment has to be in real time, to be relevant.

Further to identifying multiple users/participants, providing a context of each of the users/participants from disparate systems requires the information to be compiled, collated and rendered in a manner that is meaningful to each user of the network in real time.

After the user has collected different relevant data points of other users/participants in the network system, namely about partners or suppliers or customers, the user must evaluate the different participants/users to determine a best fit for their expertise or market alignment and consequently identify which are the most desirable. As the number of suppliers, partners and customers increases managing this assessment and ascertaining a best fit becomes more and more difficult. Beyond merely identifying relevant information, to gain some comprehension the user needs to collate and arrange the information.

The existing systems give little information about customer fit or partner fit or supplier fit. The information that existing system provide is a location info/address of market participants and a description about the activities of market participants, as follows; products made, product specifications, service rendered, and so on. This factual information does not yield if the market participant is an “actual fit” for a business proposition in terms of existing customer base, industries serviced currently, domains catered to, and so on. The “Actual-Fit” criteria can help a business prospect assess if a specific market participant (customer, supplier, partner) is a best fit as a business prospect—is there an alignment in terms of industries serviced, market size of industries serviced, specializations towards specific domains, and so on.

A need, therefore, exists for an improved system and method suited to provide easy context sharing of the professional expertise of users using a smartphone device or Personal Computer (PC). Further the system and method should enable a contextual network for users that showcase their own work expertise and relevance and helps one assess the expertise of other users in the contextual network system.

### SUMMARY OF INVENTION

The following summary is provided to facilitate an understanding of some of the innovative features unique to the disclosed embodiment and is not intended to be a full description. A full appreciation of the various aspects of the embodiments disclosed herein can be gained by taking into consideration the entire specification, claims, drawings, and abstract as a whole.

According to one aspect of the invention, a user's terminal (in PC/in smartphone) is adapted to enable easy context sharing with other users.

In another aspect of the invention, a user's terminal provides interface to access the enriched database through which the users call, check and assess other users on their network.

In another aspect of the invention to provide unique advantages over the existing social network systems by being capable of not just identifying, but correlating and collating information about other users (contacts and non-contacts) on a user's terminal (in PC/smartphone) in the context of their work expertise and professional work relevance. This stands in contrast to the existing method of just identifying a user by their phone number and or name or email or user's unique id.

In one embodiment of the present invention, a system is provided for assessing and ascertaining the work expertise and professional relevance of callers and recipients using their smartphone device or PC. To do so, the system collects call logs and contacts information from handset of a user and/or email application and/or chat application. Similarly, the contextual system can collect the log of emails/chat messages sent and received by a user on the PC/smartphone. This collected information is used in conjunction with user pre-selected information that describes a user's mobile number, name, industry, function, domain, location, organization size in conjunction with user data like designation, Company Name, website and email.

In one embodiment of the present invention in which every user who has installed the user terminal and registered to be on the contextual network, the system collects information from the smartphone/PC of the user and this information is used in conjunction with the user pre-selected information that describes the user's name, industry, function, domain, location, organization size along with user custom entered data like Designation, Company Name, Website and Email. The user is identified by at least one unique identity, for example, a mobile number and/or email and/or chat id depending on the application from where contextual system gather user's contacts and log details. Logs refer to those interactions the user has engaged in and interaction details of other users who are in contacts and non-contacts.

In one embodiment of the present invention wherein the user's network is the user's contacts and logs on the smartphone device and/or the user's network is the user's email contacts and email log (email sent and received) via an email application and/or the user's network is the user's chat messaging contacts and chat logs (chats messages sent and received) via a chat application using PC/smartphone device. In addition, the network can also comprise of other participants who are not on the user's contact list on the smartphone device and/or email contacts and or chat contacts that the user has not yet interacted or has a relationship.

In one embodiment of the present invention provides for a user terminal on the user's smartphone/PC and another server terminal system at the cloud server that provides, collects, stores and distributes services to the user. Information that has been provided by a user is stored on the smartphone and a copy is stored on the central terminal or distributed servers. The user can only describe his own profile and not his/her contacts on his network system. Information published by a user can be seen and retrieved by any other user on the network system. The retrieval however can only be engaged by knowing the mobile number and/or email and/or username and/or the external web link unique to each registered user of the network system.

In one embodiment of the present invention, wherein a user can describe his profile using the user terminal installed on the smartphone/PC. The terminal provides pre-defined business attributes to be selected by the user as well as custom fields for the user to enter their information as they choose. The user has control only on his/her own profile description and not of any of the contacts or other participants (non-contacts or other users) in the network system.

In one embodiment of the present invention wherein as the pre-defined attributes that a plurality of users choose individually are systemized and when used in conjunction with the contact and call log information (and/or email contacts and email logs and/or chat contacts and Chat logs) for each user, a schematic work profile or context for each user emerges. With the correlation between user's chosen attributes and logs, the user's context can be expressed in terms of the user's interaction with one or more business attributes such as Domain or Industry or Function or Organization size or Location. Each business attribute has specific constituents that are under the considered business attribute. For example, the Business Attribute, ‘Location’ can have Mumbai, Delhi, New York as specific constituents under the business attribute. Since the attributes are pre-defined the schematic is an objective rendition of the user and not a subjective rendition wherein a user has created using tags and description on his/her contacts.

In one embodiment of the present invention, wherein on account of an objective rendition of interactions for each contact, the professional expertise and relevance for each contact can be solicited from the user's smartphone or PC. The professional expertise and relevance of any contact of a user can be retrieved from the smartphone's memory as well as from a cloud or distributed server via WAP or 3G/4G or any internet access device or system.

In one embodiment of the present invention, wherein the user's own descriptive expertise and relevance can be shared with other users as an image or web link URL (Uniform Resource Locator). A user can share his/her own profile with contacts in the system or even outside of the social contextual network system. Further a user can share the expertise and relevance of one of his contact A with another Contact B in the system or share the profile of Contact A with Contact Z not of the same system. This sharing can be done as an image or as a web link URL. The image and/or web link URL provides the professional expertise and relevance of the user, similarly, each of his/her contacts also have such a unique web link URL/image available for view and assessment.

In one embodiment, the present invention discloses an assessing system comprised of assessing the profile of participants in the network system but outside the user's contact base. The network system enables any user of the system to custom search or select specific participants/users from the network system, get more information about their work expertise and assess their professional relevance. The system provides a user interface to assess and ascertain people expertise and relevance. This can be done via a simple search of the name of the person, company name, email, Industry, Domain, Location, Function, mobile number. The search can be on the basis of any one of these attributes or a combination thereof.

In another embodiment, an HTML embedded image on any third party business web page when clicked by a visitor can graphically render the expertise and professional relevance of the business webpage to the visitor.

In another embodiment, each registered user on the system is provided with a unique web link, wherein the web link can graphically showcase the expertise and professional relevance of that registered user.

### BRIEF DESCRIPTION OF DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the disclosure is not limited to specific methods and instrumentalities disclosed herein. Moreover, those in the art will understand that the drawings are not to scale. Wherever possible, like elements have been indicated by identical numbers.

FIG. 1 is an illustration of a block diagram of a system 100 for facilitating contextual information of business contacts and non-contacts, in accordance with the disclosed embodiments;

FIG. 2 is an illustration of a block diagram showing various functional elements of the system of FIG. 1, in accordance with the disclosed embodiments;

FIG. 3 is an illustration of a flow diagram showing a brief compilation of the interactive process that occurs between a user device (smartphone device/desktop) and the server 110 of the system of FIG. 1, in accordance with the disclosed embodiments;

FIG. 4 is an illustration of a flow chart showing method of facilitating contextual information using call logs and contacts and/or email contact and email logs and/or chat contacts and chat logs in smartphone device/PC of FIG. 1, in accordance with the disclosed embodiments;

FIG. 5 is an illustration of a flow chart showing method of generating expertise level of user for facilitating contextual information using smartphone device/PC of FIG. 1, in accordance with the disclosed embodiments;

FIG. 6 is an illustration of a block diagram showing a context collector used in the system of FIG. 1, in accordance with the disclosed embodiments;

FIG. 7 is an illustration of a flow diagram showing method of facilitating contextual information when the system of FIG. 1 is used in smartphones and in PC, in accordance with the disclosed embodiments;

FIG. 8 is an illustration of a detailed block diagram of the system of FIG. 2 both functional elements and data, in accordance with the disclosed embodiments;

FIG. 9 is a screenshot of an example diagram showing contact details of user using the system of FIG. 1, in accordance with the disclosed embodiments;

FIG. 10 is a screenshot of an example diagram showing contact and non-contacts in logs of user using the system of FIG. 1, in accordance with the disclosed embodiments;

FIG. 11 is a screenshot of an example diagram showing expertise details of user using the system of FIG. 1, in accordance with the disclosed embodiments;

FIG. 12 is a screenshot of an example diagram showing relevance details of user using the system of FIG. 1, in accordance with the disclosed embodiments;

FIG. 13 is a screenshot of an example diagram showing relevance details of user using the system of FIG. 1, in accordance with the disclosed embodiments;

FIG. 14 is a screenshot of an example diagram showing relevance details of user using the system of FIG. 1, in accordance with the disclosed embodiments;

FIG. 15 is a screenshot of an example diagram showing relevance details of user using the system of FIG. 1, in accordance with the disclosed embodiments;

FIG. 16 is an illustration of a block diagram showing various functional elements of the computer of the system of FIG. 1, in accordance with the disclosed embodiments;

FIG. 17 is an illustration of a general flow diagram showing process of displaying results using email service, in accordance with the disclosed embodiments;

FIG. 18 is an illustration of a flow diagram showing process of facilitating contextual information when the system of FIG. 1 used as plugin for browser, in accordance with the disclosed embodiments;

FIG. 19 is an illustration of a flow diagram for simplified process of facilitating contextual information using FIG. 18, in accordance with the disclosed embodiments;

FIG. 20 is an illustration of a block diagram showing various functional elements of the computing device of the system of FIG. 1 when used as email terminal, in accordance with the disclosed embodiments;

FIG. 21 is an illustration of a block diagram showing various functional elements of the computing device of the system of FIG. 1 when used in browser, in accordance with the disclosed embodiments; and

FIG. 22 is an illustration of a flow diagram of searching user using Email ID or Mobile number or user name or company name using system of FIG. 1, in accordance with the disclosed embodiments.

### DESCRIPTION OF EMBODIMENTS

The particular configurations discussed in the following description are non-limiting examples that can be varied and are cited merely to illustrate at least one embodiment and are not intended to limit the scope thereof.

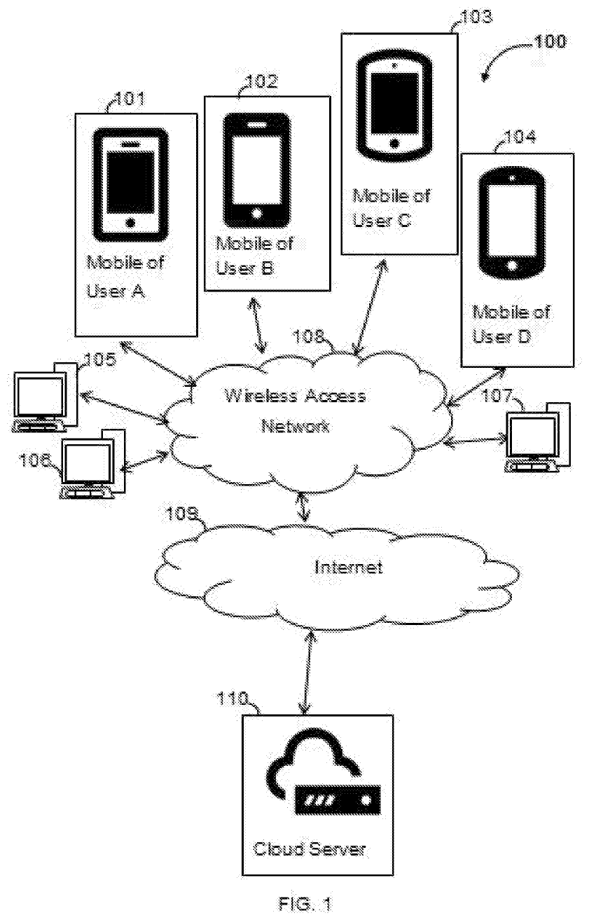

FIG. 1 is an illustration of a block diagram of a contextual network system 100 for facilitating contextual information of business contacts, in accordance with the disclosed embodiments. The system 100 comprises of a plurality of users connected to a server 110 via at least one wireless access network/wired network 108 and internet 109. The wireless network 108 allows a device 101 to 107 to access the internet 109, wireless network 108 can be a WIFI/Bluetooth network or 3G/4G cellular network or any other network that provides the device access to the internet. The user accesses the system server 110 by virtue of a contextual terminal 151 executed on the computing device: smartphone 101, 102, 103 and 104 or PC 105, 106 and 107 of the user. The server 110 can be a centralized terminal server 110 or even a distributed server or a cloud server without limitation. The system 100 is capable of clustering and collating information about users of the smartphone devices 101, 102, 103 and 104 or PC 105, 106 and 107 and render contextual information about the user's work expertise and professional work relevance.

The contextual network system 100 consists of the frontend contextual terminal 151 on the user's smartphone device 101, 102, 103 and 104 or PC 105, 106 and 107 and a complimentary server terminal at the cloud server 110 that provides, collects, stores and distributes services to the user. Information that has been provided by a user is stored on the phone device 101, 102, 103 and 107 and a copy is stored on the central terminal or distributed servers 110. The user can only describe his own profile and not his/her contacts on his network system. Information published by a user can be seen and retrieved by any other user on the network system. The retrieval of user information and user contextual information can be engaged with the installation of the contextual terminal 151 by users or by accessing an external web link which has been provided by the registered user to recipients. For registered users, the user contextual information can be the rendered for user's contacts and user's log entities where the user's contacts and user's log entities are also users of the contextual terminal/system 151.

For every user who has installed the terminal and registered to be on the network, the system 100 collects interaction information from the smartphone device 101, 102, 103 and 104 or PC 105, 106 and 107 of the user and this information is used in conjunction with the user pre-selected information that describes the user's industry, function, domain, location along with user custom entered data like designation, company name, website email and mobile number.

The user's network 108 is the user's contacts and call logs and/or the user's email contacts and logs (email sent and received) and/or user's chat contacts and chat logs (email send and received). In addition, the network 108 can also comprise of other participants who are not on the user's contact list on the smartphone device and/or email contacts and/or chat contacts that the user has not yet saved in contacts. Such participants whom the user has not yet saved in contacts are called non-contacts. Participants that the user has saved in the device are called contacts. Log would comprise all interactions with contacts and non-contacts such as calls made/received or email sent/received or chat sent/received.

The computing device 101 to 107 and/or the user terminal 151 installed in the computing device comprises at least one contact data and/or non-contact data, wherein the contact data is at least one unique identity of at least one contact and/or at least one non-contact data is at least one unique identity of at least one non-contact in the computing device and/or the user terminal. The contact data stored is with at least one user information, for example user name, industry, domain, function, organization size, Company name, Designation, website, email, and related details, in at least one storage device of the computing device. The non-contact data are not stored in the computing device but are displayed to the user until the user clears the data.

In one embodiment of the present invention, the professional expertise 251 and relevance 252 for each contact can be solicited from the user's smartphone device 101, 102, 103 and 104 or PC 105, 106 and 107 using the contextual terminal 151.

It should be noted that FIG. 1 is a scenario where multiple users using smartphone device 101, 102, 103 and 104 or PC 105, 106 and 107 are accessing a network, not necessarily the same network, it can be distinct with the common function of the networks 108 providing access to the users of devices 101-107 to the internet 109. With access to the internet, users can search partners, prospects, customers or suppliers but are not equipped to discern if such prospects can be a suitable match for their proposed endeavors. Such an assessment is a particularly difficult process for the users to manage or even arrive at because it requires multiple kinds of data at various interactions points and inputs from various different systems as all data points are not on one system. Beyond merely identifying relevant information, to gain some comprehension the user needs to collate and arrange the information in a visual manner that can be easily grasped. This job of collating and arranging the information data points To provide information in a visual manner that can be easily comprehended would be more likely to assist the user in making important decisions.

For example, knowing the kind of industry interactions a prospective supplier has, can help the user review and select suppliers who are more aligned to the user's industry. A similar discernment can be adopted by users with customers who are better aligned to specific industries and domains. Such a context can mitigate time and resources otherwise spent. This kind of a comprehension can be readily ascertained using a visual context to render relevant information about participants in multiple systems. With the system described, users with access to the internet are in a particular position to assess and communicate their professional expertise and relevance to other users on the system by means of the contextual terminal system.

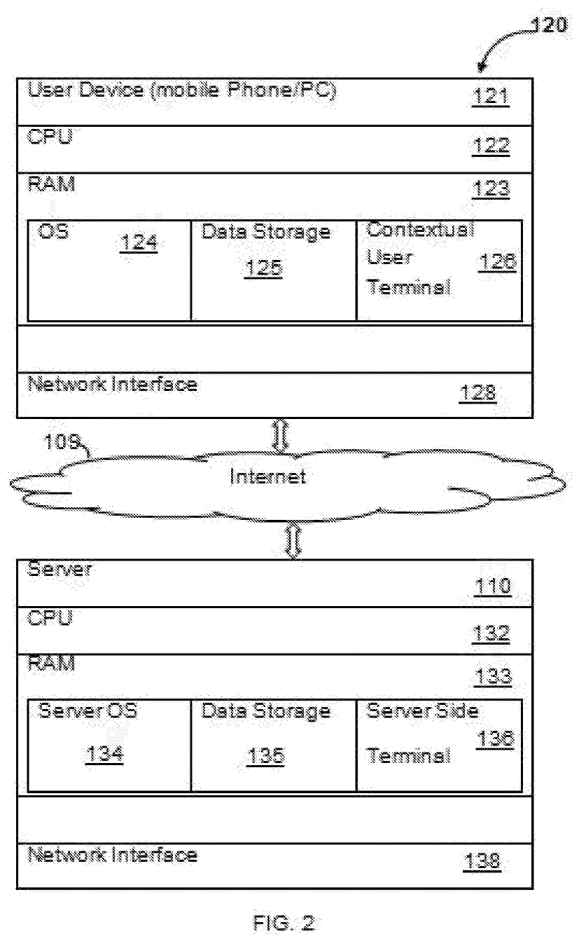

FIG. 2 is an illustration of a block diagram of various functional elements 120 of the system 100 of FIG. 1, in accordance with the disclosed embodiments. The user device (smartphone device/PC) 121 comprises a CPU 122, RAM 123, OS 124, data storage 125, installed contextual terminal 126, and network interface 128. The server 110 comprises a CPU 132, RAM 133, OS (Operating System) 134, data storage 135, installed server side terminal 136 (backend of the contextual system), and network interface 138. The contextual terminal when installed solicits and processes data gathered from the device/PC using the device's CPU 122 and RAM 123. This data gathered has to be collated and charted using the RAM 123 and CPU 122 of the device/PC 121 to render the user's expertise and relevance on the device. Data that has been collated and chartered is stored in device storage 125. A copy of this data is sent to the distributed or cloud server using the network interface 128 of the device 121. The server 110 receives and stores this data in its storage 135. The server 110 is continuously compiling data from the plurality of users on the system and updates the data if any changes have been rendered by the user and when data records change from day to day with new interactions by the plurality of users.

The CPU 132 and RAM 133 of server 110 is used to render the charts of a user's expertise and relevance that is represented as a unique web URL. The server 110 renders the charts when any recipient of the unique web URL enters this URL into their browsers to solicit a registered user's unique web URL The server 110 also checks on and updates user's data if it has been changed or updated by a registered user A and/or when the new records of interactions are received by the contextual system. As the contextual information for user's changes with interactions, this data has to be processed and pushed to the plurality of users 162 if they are part of registered user's contact list. The server 110 does such a periodic check of information for the plurality of users and updates that information unto the devices of the plurality of users 162.

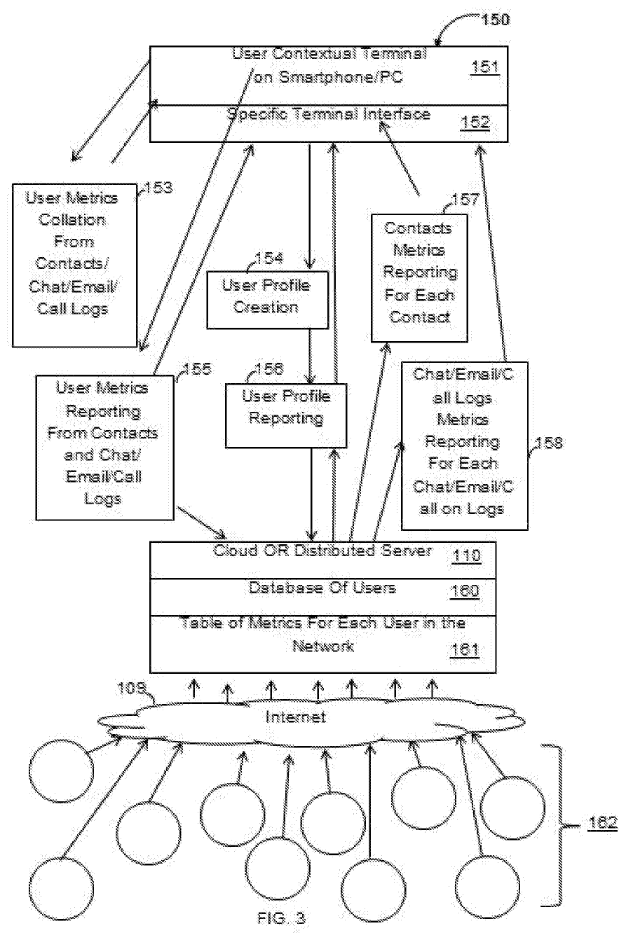

For simplicity, the smart phone device 101, 102, 103 and 104 or Personal Computer (PC) 105, 106 and 107 of the user are together generally referred as a computing device 121 in FIG. 3. FIG. 3 is an illustration of a flow diagram showing a brief compilation of the interactive process 150 that occurs between a user device (smartphone device/PC) 121 and the server 110. User device would be represented by the smartphone/PC device 121. A contextual user terminal 151 is used to compile call/email/Chat contacts and/or call/email/Chat logs. The logs would represent the incoming and outgoing interactions in terms of calls made and received and/or email sent and received or chat messages sent and received. Installation of the contextual terminal on the smartphone/PC device 121 would enable a compilation of contacts 153 and logs 155. In conjunction with the compiling activity 153 and 155 for a user, the user terminal will initiate requests to the server 110 to send and retrieve information 157 and 158 about each contact and log entity for a user.

Each user's contact (and log entity) profile and contextual information are available on the server 110, if contacts and log entities are registered on the contextual system 100. If not on the server, then that contact would not have any compiled information available on the server 110, in such a case the server would retrieve null information. For each contact's and log entities compilations, the server 110 has a database 160 for users and a table 161 of data for each user in the network. The user if a first time user on the terminal is solicited to enter user information 154, this information is reported 156 to the server 110 and as the user continues to use the terminal, user specific interaction reports are sent to the server 110. This enables the contextual information rendered to be as close to real time as possible. Any changes in information of the contacts of the user will get reflected in the table 161 of the server 110 and is updated to the terminal 151 at the next timed update/synchronization. The server 110 would be updating information records as it receives it and then disseminates the information to the devices 121 to keep the contextual information of the contacts relevant as close to real time as possible.

The information of each user on the contextual terminal 151 is stored in the server 110 and this collection of user information in database 160 is seamlessly updated as interactions between each user and their contacts are engaged. The terminal 151 would be in a position to render contextual information in table 161 even for entities in the logs that are not on the contacts of the user, as the log entities could have information if registered on the system available on the server 110. Data that is computed for each user, their contacts and their log entities are maintained in the server 110. This data in database 160 and table 161 is updated between the user's device 121 and the server 110 on a continuous basis. FIG. 2 is a representative diagram between a user and a user's contacts, this model is replicated across the plurality of users 162 and those user's contacts who have installed the contextual terminal 151 on each of their respective devices 121. Given the network contextual system, as the contacts and users and log entities are on a network system, each of their contextual information is available for view to other participants (other users) 162 in the network system.

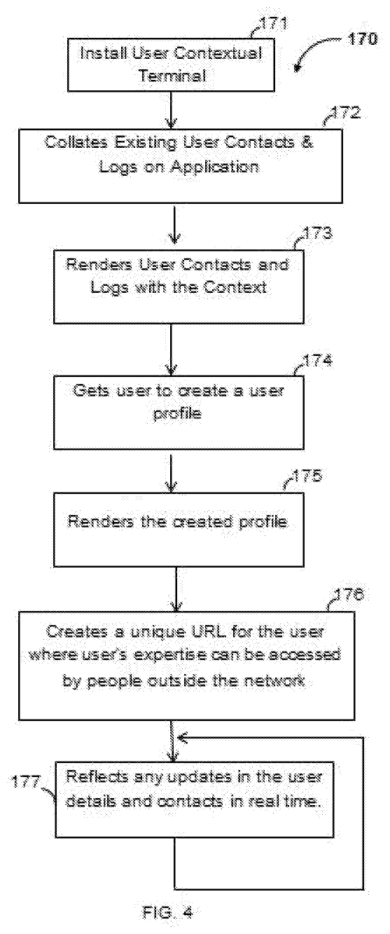

FIG. 4 is an illustration of a flow chart 170 showing a method of facilitating contextual information using logs and contacts in a user's device 101 to 107 of FIG. 1, in accordance with the disclosed embodiments. The user installs the contextual terminal 151 in the device 121 (Smartphone/PC), as at step 171. Then, as at step 172, the terminal 151 collects existing user contacts and logs details (unique identifiers/identity for contacts and logs such as a mobile number or email or username), from the device 121 and matches that with information (the unique identifier) about contacts 157 and logs 158 on the server. The system then renders the user's contacts and call logs with the contextual information if matched, as at step 173. As at step 174 and 175, the system then solicits the user to create a user profile and showcases the created profile to the user. The system creates a unique URL for the user where user's contextual information namely the expertise and relevance can be accessed by people outside the network, as at step 176. The system also allows users to reflect any updates in the user details and contact in real time, as at step 177.

FIG. 5 is an illustration of a flow chart 180 showing a method of generating expertise and relevance of user in effect which facilitates contextual information using device 121 (smartphone/PC) of FIG. 1, in accordance with the disclosed embodiments. As at step 981, the system allows users to install and register the terminal 151 in the smartphone device/PC 121. The terminal 151 processes rules for generating user profile and compiles the information necessary for building the contextual information, as at step 982 and 983. The raw data about user interactions is collected from the device 121. Then, as at step 984, the user interaction data is processed to form the contextual information for the user and the user's contacts with confidence levels as at step 985. In case, as at step 985, more data is needed to build the user's expertise and relevance, then the system initiates actions for the user to complete by push messaging or notifications. Then, as at step 986, system periodically checks to see if the initiated actions have built results to render the contextual information as at step 987, if not the system again re-initiates actions for the user to complete. If the user's action builds results, as at step 988, the results are compiled into processed data to form the contextual information for the user. This new data is periodically gathered as the user's network expands based on the contacts and log information, as at step 989. Finally as at step 989, the system, keeps on checking for the network expansion and accordingly keeps updating the user's expertise and relevance (contextual information).

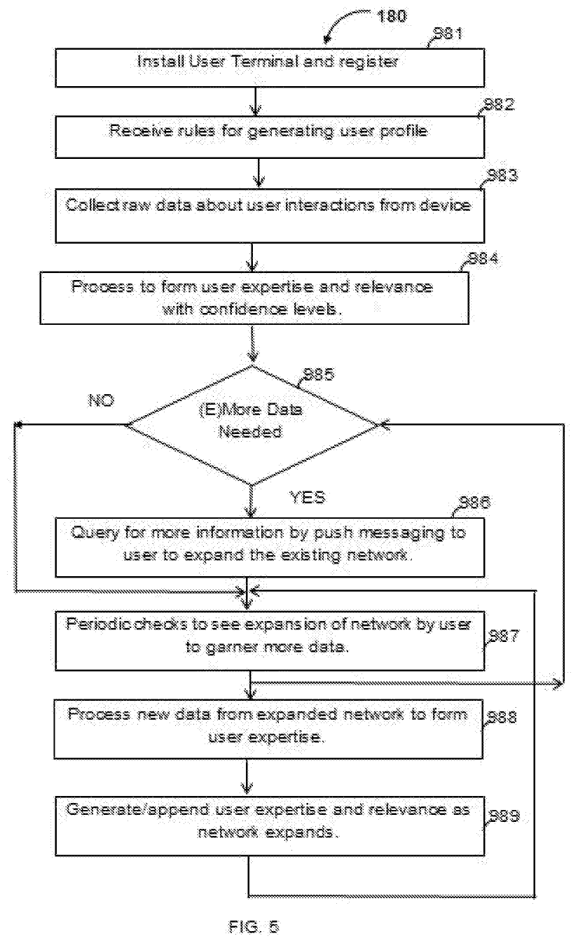

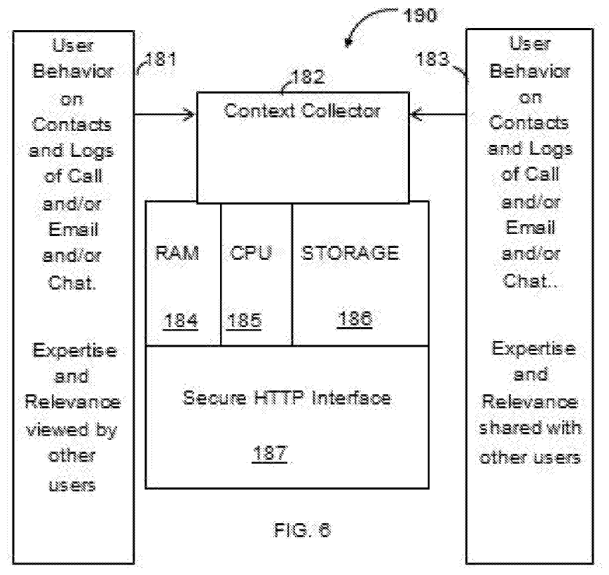

FIG. 6 is an illustration of a block diagram 190 showing a context collector 182 used in the system 100 of FIG. 1, in accordance with the disclosed embodiments. The context collector 182 is part of the user terminal 151 that processes the user's interactions over the device 121 over stipulated time periods. The context collector 182 initially takes its information from the devices contacts and logs 181 and 183, but as the device 121 has limited functionality of measuring the type of interactions over a wide variety of permutations and combinations, the context collector 182 supplants the 121 device's measurements and data about contacts and logs by taking over this function from the device and doing this function itself. The context collector 182 of the contextual terminal system 151 utilizes the network adaptors 187, RAM 184, CPU 185, storage of the device 186 and uses APIs to interact with device/email application/chat application. The RAM 184 and CPU 185 of the device is used to process the data of contacts and logs into tables and collates information that can be easily used for rendering the contextual information. The context collector 182 is programmed to run a variety of permutations and combinations on the interactions between a user, the contacts and logs to yield information about the type of interactions. The context collector 182 stores this information in the storage of the device 186 which is used for rendering the contextual information of a user. The context collector 182 also records interactions (181 and 183) that a user has done on the contextual terminal system 151, by viewing of contact's expertise and relevance, tracking which contacts have viewed the user's expertise and relevance, time sequences of viewing, number of times viewed, sharing of contextual information with contacts, time sequence of such sharing, and so on These interactions done by a user on the system is collated and added to enhance the contextual information of the user's expertise and relevance. The contextual terminal 151 also needs to communicate this data with the server 110, to relay 151 this information using the device's network interface 187.

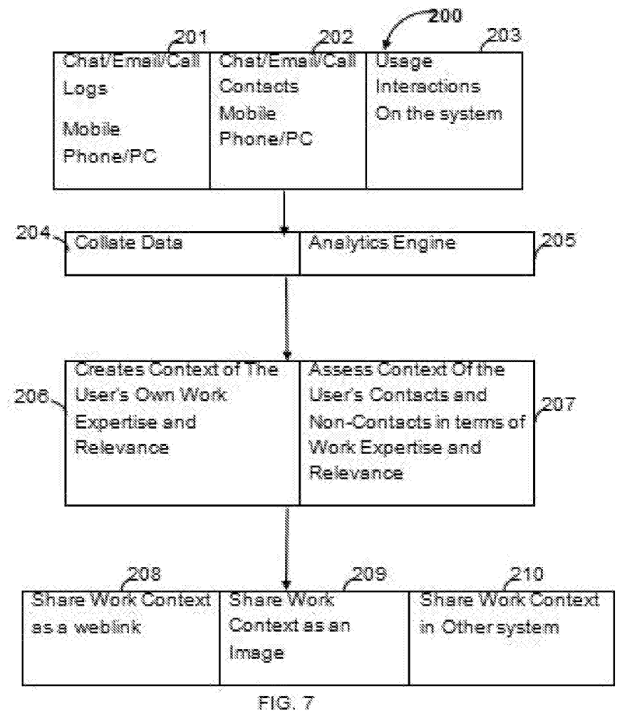

FIG. 7 is an illustration of a flow diagram 200 showing method of facilitating contextual information when the system of FIG. 1 is a smartphone device or PC 121, in accordance with the disclosed embodiments. When a user has registered on the system, as at blocks 201-204, the system collects Chat/Email/Call log data, contacts data and usage interaction from the user's device 121 (smartphone or PC). The system also solicits data forms, allocates additional analytical information specific to the user, as at block 205. The analysis involves the interactions a user has had with the user's contacts and call logs. This data collected from the user facilitates contextual information of the user to be sent to other users on the network as well as to the distributed/central System server 110 of the contextual network system. The user's device 121 is a smartphone/PC and data activity consists of Chat Messaging/Email/call logs, contacts (Chat/Email/Call), time of activity, duration of activity and so on. Each user is recognized by a unique Identity (ID) on the network which can be the mobile number or an assigned unique number by the system. The system uses APIs to read, retrieve from device/email/chat application and store data between the user's terminal 151 and central terminal server 110. As at block 206 and 207, the system creates the Contextual information of The User and expressing it as a user's Expertise and Relevance and allow the user to similarly view and Assess Contextual information Of the User's Contacts and Non-Contacts in terms of Work Expertise and Relevance. The user is in a position to assess each contact and log entities in terms of each of their expertise and relevance. The user can share one's own contextual information or of the contacts or log entities using the unique web link of each contact or log entity. Hence, as at blocks 208, 209 and 210, the user can also share it as an image or web URL or share it via any other systems, respectively.

Similarly, in the system 100 the plurality of registered users 101 to 107 and therewith each user in the database has a specific constituent as business attribute in Industry and/or Domain and/or Function and/or Location and/or Organization Size and/or Website and/or Company Name and/or Designation associated therewith, and wherein at least one of the business attributes associated with each of the users of the database comprises a representation of those business attributes for user. This will enable users to be collated under a common Industry or Domain or Function or Location or Website or Company name or Designation or Organization Size or a combination of multiple business attributes thereof. Further the business attributes can be collated by a combination of time of interaction and/or frequency of interaction along with at least one business attribute associated with each of the users.

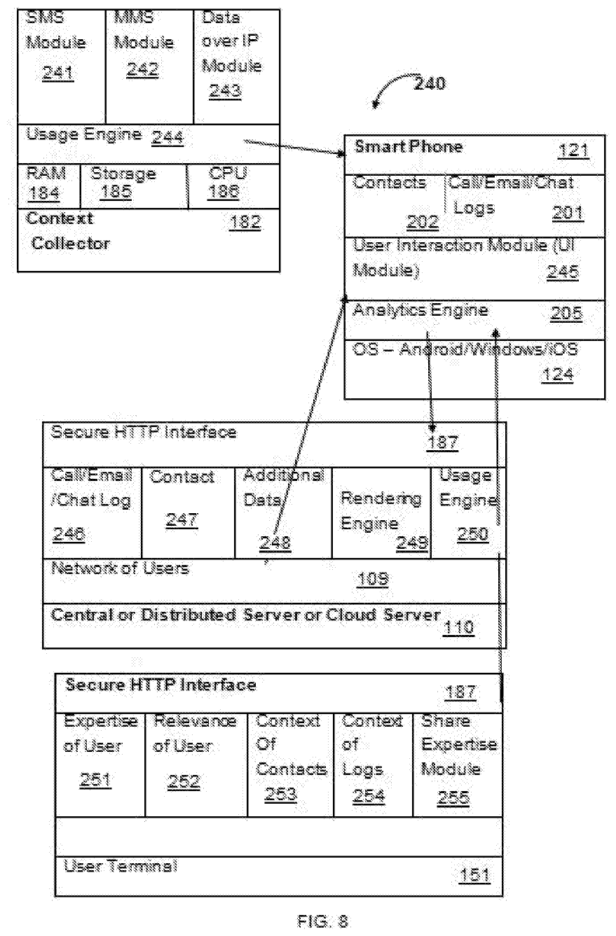

FIG. 8 is an illustration of a detailed flow diagram 240 of the system of FIG. 1 both functional elements and data, in accordance with the disclosed embodiments. According to one embodiment of the system of invention, the system architecture comprises of a user device (smart phone/PC) 121, a set of terminal service modules 240 providing services to smart phone 121 and/or desktop, context collector 182, user terminal 151 and a centralized server 110. The centralized server can be a distributed or a cloud server. The context collector 182 sits in the user interaction module 245 of the smart phone 121, and uses the HTTP interface 187 to communicate with the user terminal 151 and server 110.

The user terminal 151 installed on the (Operating System) OS 124 of the smart phone 121 consists of an analytics engine 205 and a context collector 182, user interaction module 245

The User Interaction Module 245 of the smart phone 121 is the front end and enables users to get contextual Information on the user's device 121. Initially, the terminal 151 on the user's device connects to the server 110 to provide build a context for the user of the device 121. To do so, the terminal 151 needs additional information 248 about each contact 201 and log entity 202 of the user. This additional data 248 is accessed from the server 110 using a secure HTTP (Hyper Text Transfer Protocol) interface 187. With the additional data 248 about contacts 201 and log entities 202, the analytics Engine 205 calculates the information about the user in conjunction with information from the context collector 182 and is finally showcased as Expertise 251 and Relevance 252. Once the process to render contextual information of the user has been initialized, the terminal 151 also retrieves contextual information for the contacts 253 and logs 254 of the user from the server. The terminal 151 synchronizes with the central server 110 and checks for updates on new and existing logs and contact information, assess changes and updates the information to the user terminal 151. The centralized server collates 248 and stores the information retrieved for each user from the user's terminal 151. A user of the terminal 151 can share expertise 251 and 252 using the share module 255, in addition the user can share contextual information of the contacts and logs 253 and 254 amongst them.

The UI (User Interface) module 245 calls upon the user terminal 151 to render information as and when required using HTTP or any such standard protocol as implemented by the User Terminal 151.

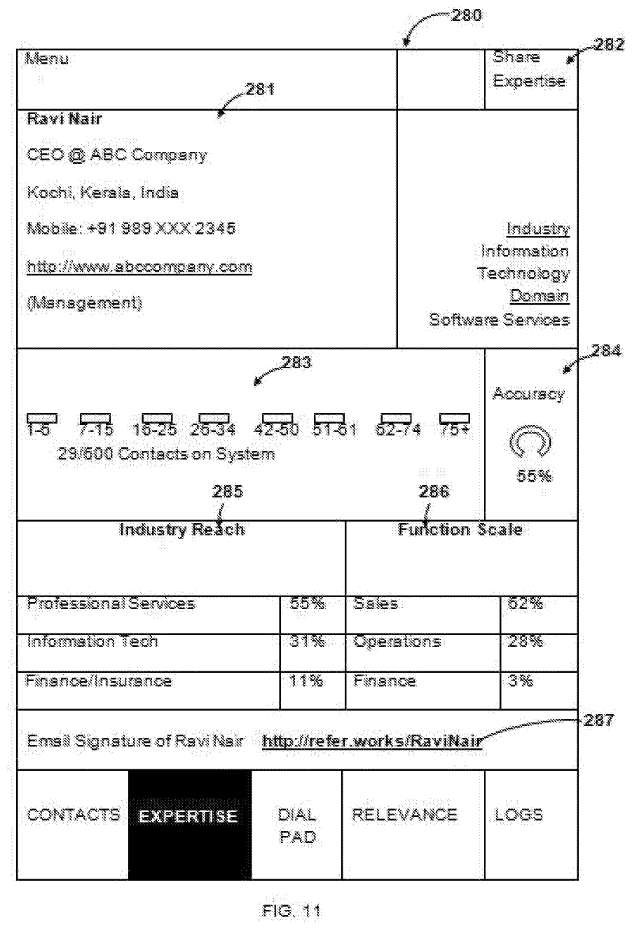

The context collector module 182 is depicted in FIG. 6. The users can share contextual data with another user in and out of the network using a simple messaging service 241 or multimedia messaging service 242 or email 243 or online messaging service. The usage engine 244 in the context collector 182 tracks and records the Interactions that a user has with contacts and log entities and further yields information about interactions in terms of business attributes such as industry, domain, function and location. This collected data is then added to enhance the information of the user and express it in terms of the expertise 251 and relevance 252 of the user. In addition, the usage engine 244 collects and collates so as to display information as contained in FIG. 12 to FIG. 15. The usage engine 244 in the context collector is collating information for the user who has installed the terminal on the PC/smartphone. In case the contextual information is provided as a web URL, the rendering engine 249 facilitates this information to be viewed on a browser. The usage engine 250 on the server 110 stores information on the plurality of users 109 and their interactions which are collected from usage engine 244 for each registered individual user on the system; it also records and assesses information of the web URL solicited from the server 110. Interactions for the network of users 109 with their contacts 246 and log entities 247 is stored in the server 110.

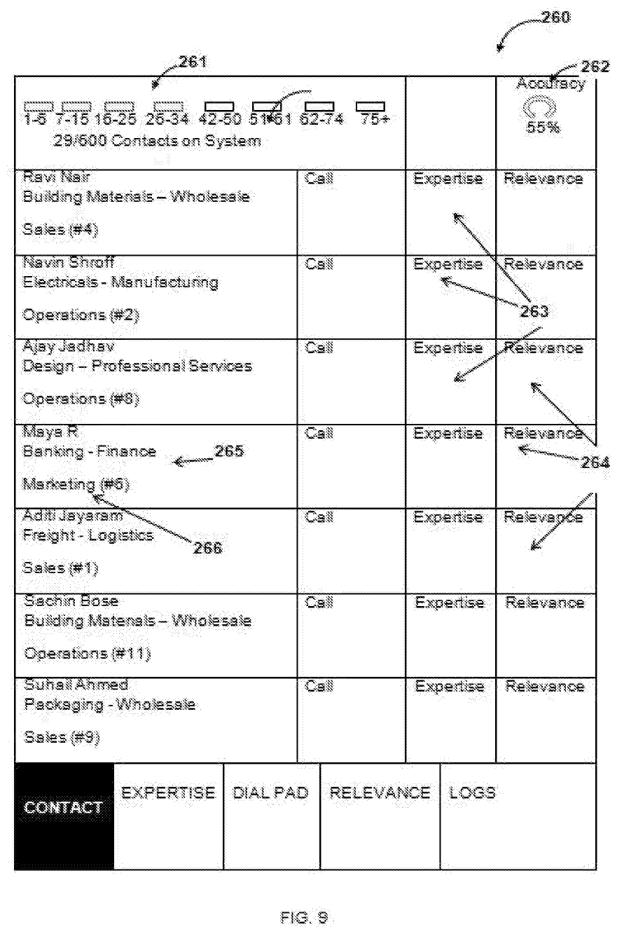

FIG. 9 is a screenshot 260 of a user's contacts arranged using the contextual terminal of FIG. 1, in accordance with the disclosed embodiments. According to an embodiment of the invention, the contextual information about a user's contacts as well as the ability of a user to share and provide a user's own contextual information is provided through the internet 109. In one embodiment, the contextual information, for example, expertise 263 and relevance 264 about the user's contacts 261 can be provided to the user on a smart phone/PC. For each contact, if the contacts are registered users of the contextual terminal 151, Expertise 263 and Relevance 264 is viewable. The number of contacts 261 that are on the user's network is shown as in FIG. 9. An accuracy indicator 262 which indicates the confidence level of the user's contextual information is provided. A high confidence level of a user's expertise 263 and relevance 264 would be reflected with a high Accuracy Level. The industry or domain 265 as well as function 266 can be readily availed for a user's contacts

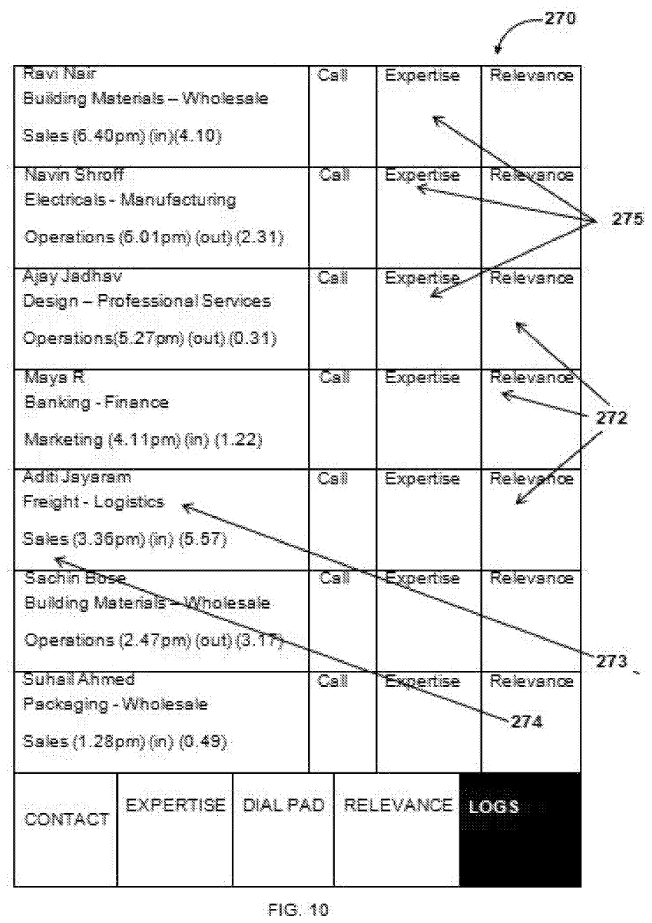

FIG. 10 is a screenshot 270 of an example diagram showing logs 275 of user's interactions with non-contacts and contacts using the system of FIG. 1, in accordance with the disclosed embodiments. This shows a display of logs 275, the user's interactions with contacts and non-contacts are showcased and their respective Expertise 271 and Relevance 272 can be viewable to the user. The Industry/Domain 273 as well as function 274 can be readily availed for a user's log entities.

FIG. 11 is a screenshot 280 of an example diagram showing expertise details 281 of user using the system of FIG. 1, in accordance with the disclosed embodiments. A user can choose to share 282 expertise and relevance with any other contact whether in the network or out of the network. The ability to share 282 one's expertise and relevance is by using the share button 282 or the web link (web URL) 287. The web link 287 is unique to a user, and provides the user's expertise and relevance. An accuracy indicator 284 which indicates the confidence level of the user's contextual information is provided. A high confidence level of a user's Expertise and Relevance would be reflected with a high Accuracy Level. The number of contacts on the user's network is indicated by a progress bar 283. A brief preview of the top three industries 285 reached by the user and function scale 286 reached by the user. Expertise as shown as a screenshot 280 is available for contacts 260 and non-contacts 270 of the user.

FIGS. 12 to 15 are screenshots of example diagrams showing relevance details of the user or contacts or non-contacts using the system 100 of FIG. 1, in accordance with the disclosed embodiments. FIG. 12 is the first in the sequence 290 of four aspects of a user's or contact's or non-contact's—Relevance. FIG. 12 is tabbed as Proximity 292. It showcases the interaction 296 of that specific user by specific constituents for the business attribute “Industry” in terms of Calls Made/email sent/chat sent and Calls Received/email received/chat received. Table 297 indicates four aspects: (1) Accuracy—which is the confidence level of the Relevance for the user, (2) Contacts—the number of contacts, this user has, who are also contextual terminal users, (3) Expertise Viewed By—indicating the number of users who have seen this user's Expertise and Relevance and (4) Expertise Viewed of—indicating the Expertise and Relevance viewed of other users on the network.

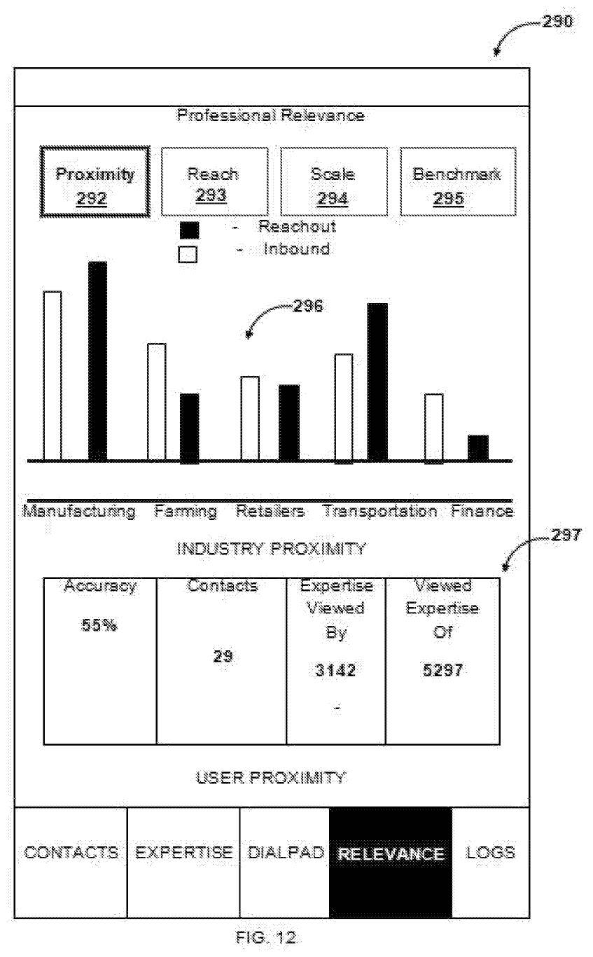

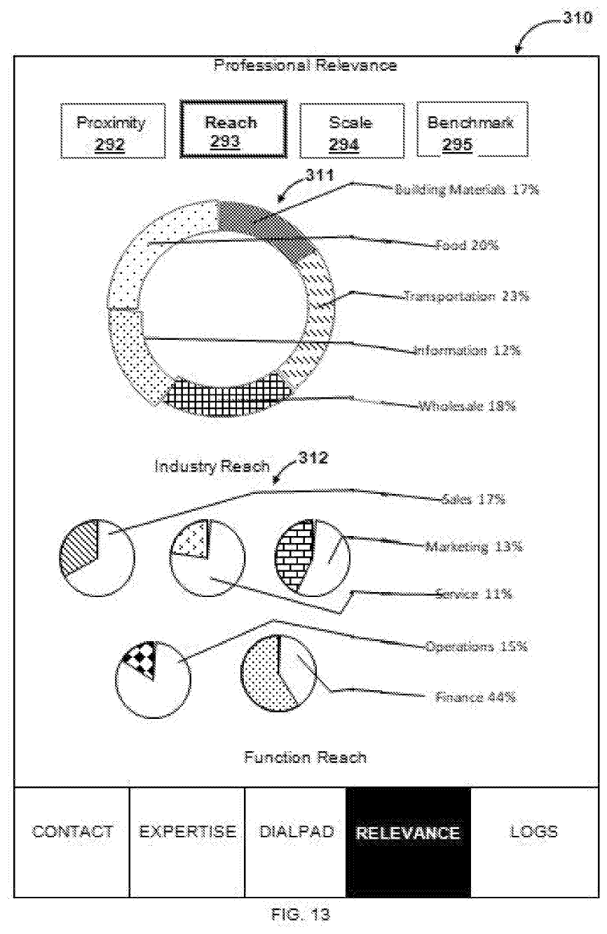

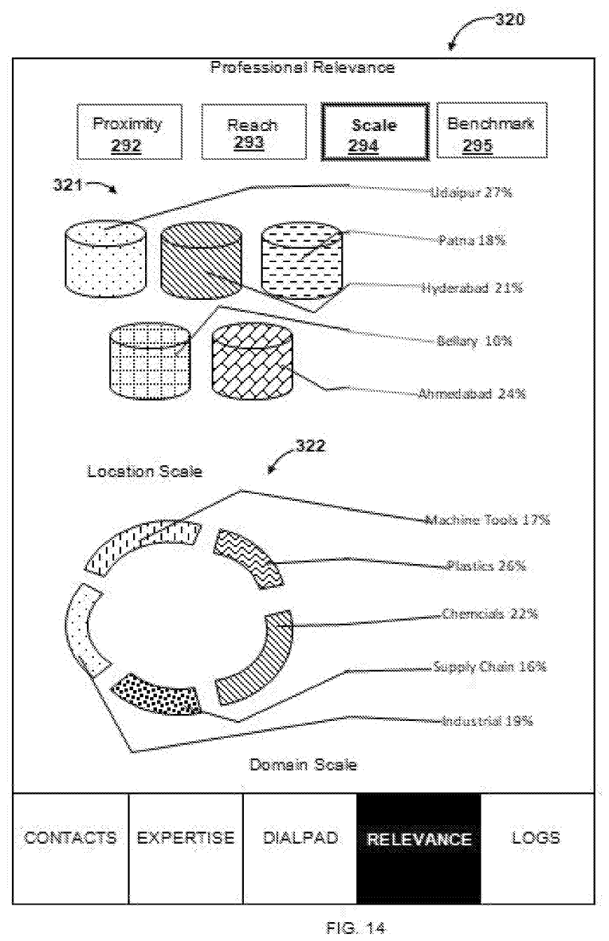

FIG. 13 is the second in the sequence 310 of four aspects of a user's or contact's or non-contact's—Relevance. FIG. 13 is tabbed as Reach 293. It showcases the Top #5 interactions 311 of the user in terms of specific constituents in the business attribute Industry. It also showcases the Top #5 interactions 312 of the user in terms of specific constituents in the business attribute Function. FIG. 14 is the third in the sequence 320 of four aspects of a user's or contacts or non-contacts Relevance. FIG. 14 is tabbed as Scale 294. It showcases the Top #5 interactions 321 of the user in terms of specific constituents in the business attribute Location. It also showcases the Top #5 interactions 322 of the user in terms of specific constituents in the business attribute Domain. FIG. 15 is the fourth in the sequence 330 of four aspects of a user's or contacts or non-contacts—Relevance. FIG. 15 is tabbed as Benchmark 295. It showcases the Top #5 interactions 331 of the user in terms of specific constituents in the business attribute Industry as clustered from Call/email/chat Logs. It also showcases the Top #5 interactions 332 of the user in terms of specific constituents in the business attribute Function as clustered from Call/email/chat Logs. The four sequences Proximity, Reach, Scale and Benchmark together provide the context of user's in terms of the business attribute Industry, Function, Location, Domain and/or Organization Scale. The context can be customized to show a single or a combination of business attributes within a specific time frame (week, Month, Quarter) or by frequency or recency of interactions. Such a context can help the user ascertain and assess the business relevancy of the user as a Customer or Vendor or Partner.

In the case of a smartphone the interactions measured are contacts and call logs on the smartphone, whereas, in the case of email application/messaging application the interactions measured are email contacts and email logs or Messaging contacts and Messaging Logs on the device 121 (PC/Smartphone). The contextual system measures interactions between a user and the user's communicative network, one based on contacts and call logs and/or email contacts and email logs and/or messaging contacts and messaging logs on any device 121 (smartphone or PC). It should be noted that as the modality of measuring interactions and building an expertise/relevance for a user is the concept of the present invention. The peculiarity is to measure interactions whether call logs and contacts on a smartphone device vs email logs and email contacts in an email service/email application used on a smartphone device/PC 121 and/or even messaging logs and messaging contacts in a messaging application and/or for that manner any communicative framework consisting of contacts and Log of Interactions. The computing device 105, 106 or 107 can be a personal computer, compact computer, PDA, portable computer, and the like, without limitation.

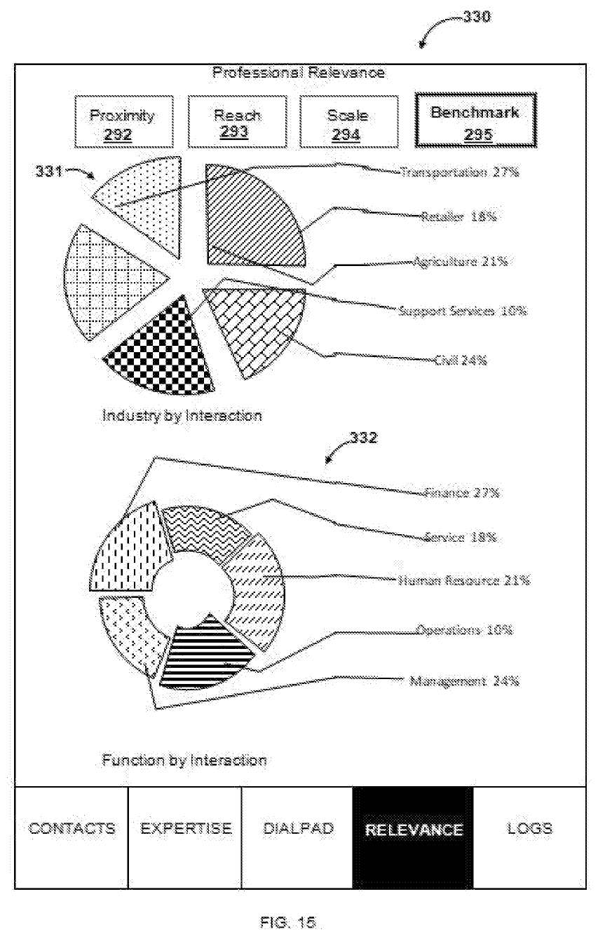

FIG. 16 is an illustration of a block diagram 340 showing various functional elements of the system 100, in accordance with the disclosed embodiments. The computing device 121 comprises an OS (operating system) 341, at least one browser 342 and/or at least one plugin 343 for browser. A Chat/Email Service is accessed using the Gmail/Hotmail/Yahoo/Slack in a Browser 344.

Using RESTful API for each email service, specific data can be availed like a user's contacts and mail logs in the user's mailbox. Each distinct user mail identity can be correlated to associated user attributes, such as name, company name, industry, domain, function, location, organization size, website, designation and mobile number. Further each user mail (sent/received) can be attributed as an interaction. Each email can be considered as an interaction (similar to a call made or received on a phone) and the number of emails sent/received between two or more users where each user's sent/received mails can be considered as calls made/received and implies a formal/informal relationship between the two or multiple users. These interactions can be correlated for industry, domain, function, location and thus help in segregating the interactions in terms of industry, domain, function, organization size and location. As the data is collated for each user, a user's expertise and relevance can be availed using email contacts and email logs, just as in the case of contacts and call logs on the smartphone device 101 to 104.

Using RESTful API for chat/messaging services, specific data can be availed like a user's contacts and chat/messaging logs. Each distinct user number/user ID can be correlated to associated user attributes, such as name, company name, industry, domain, function, location, organization size, website, designation and email. Further each user's chat/messages (sent/received) can be attributed as an interaction. Each chat/message interaction can be considered as a call (similar to a call made or received on a phone) and the number of messages between two users where each user has sent/received messages/chat can be considered to imply a business relationship between the two users. These interactions can be correlated for industry, domain, function, location, organization size and thus help in segregating the interactions in terms of industry, domain, function, organization size and location. As the data is collated for each user, a user's expertise and relevance can be availed, just as in the case of contacts and call logs on the smartphone device 101 to 104.

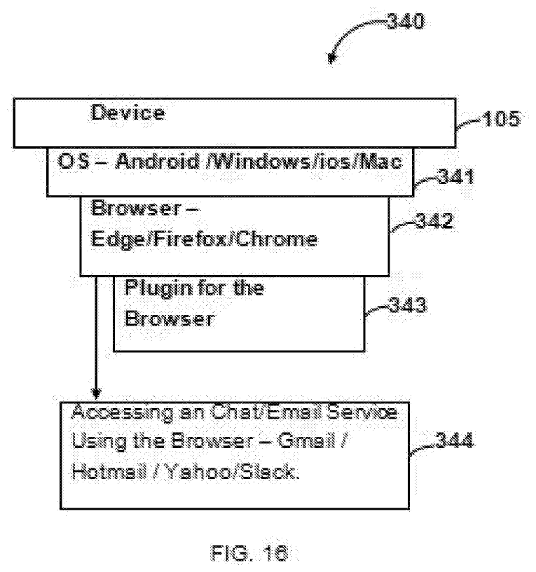

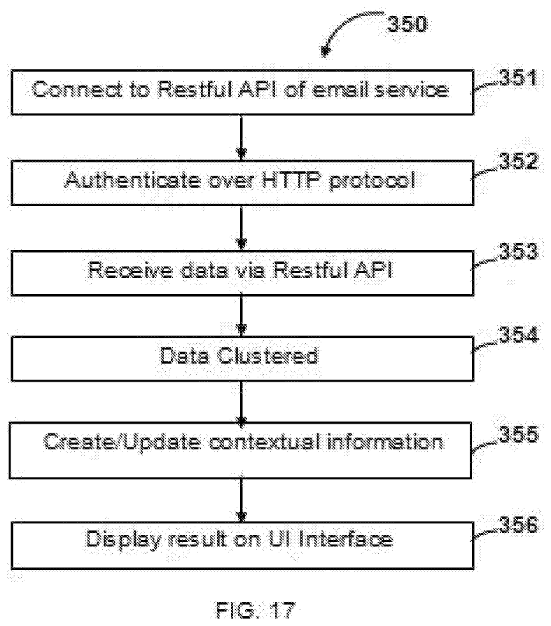

FIG. 17 is an illustration of a general flow diagram 350 showing process of displaying contextual information when using email service/chat messaging service, in accordance with the disclosed embodiments. The system connects to Restful API of the email/chat messaging service and authenticates the user details over HTTP protocol, as at step 351 and 352. The contacts and logs and other related data are received from the email/chat messaging service via restful API, as at step 353. Then, the received data are clustered 354, contextual information is created or existing contextual information is updated and results are collated on the plugin on the browser, as at steps 355. Finally the results are displayed on the user interface in the browser plugin, as at step 356. A copy of the user's contextual is also stored on the server 110.

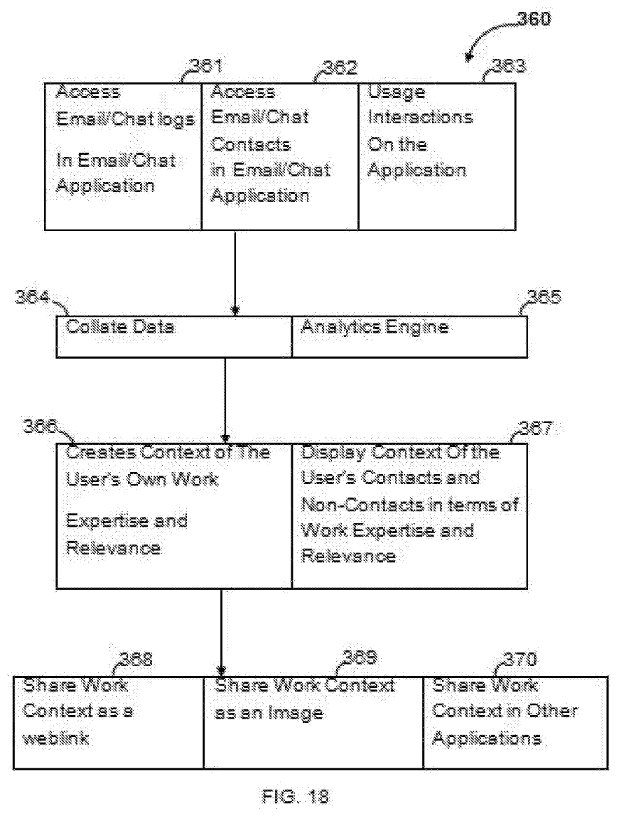

FIG. 18 is an illustration of a flow diagram 360 showing process of facilitating contextual information when the system used as plugin for email application/Chat Application, in accordance with the disclosed embodiments. The email/chat logs 361, email/chat contacts 362 and email usage interactions 363 on the email application are accessed and data 364 are collated using analytical engine 365. The context of the user's own work expertise and relevance are created using the collated data, as at step 366. The context of the user's contacts and non-contacts in terms of work expertise and relevance are displayed to the user, as at step 367. The user can share the work context as a web link 287 or an image or can share in other applications, as at steps 368, 369 and 370.

In one embodiment, the contextual information for users in a network or multiple networks can be showcased within the third party applications, by accessing the API of the contextual terminals. A user of the third party application can access the contextual information of users on the third party application through the user interface provided on the third party application which has connected to the APIs of the contextual server 110. Third party applications can graphically render the expertise and professional relevance of the users on the third party application itself. This is enabled for the third party application by accessing the APIs of the contextual terminal.

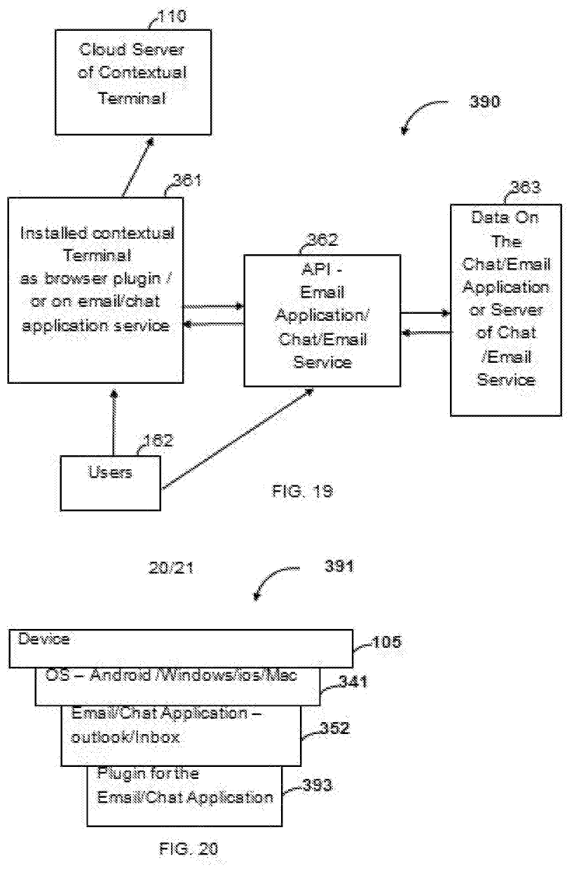

FIG. 19 is an illustration of a flow diagram 390 for simplified process of facilitating contextual information using FIG. 18, in accordance with the disclosed embodiments. The user 162 of an email/chat messaging service can accesses the contextual information of other users on the email/chat application itself or on the browser 361. The contextual terminal 361 seeks authentication to access data on the chat/email application or chat/email service through API 362. The API 362 issues access and token to the contextual terminal from email/chat application or email/chat service. This allows the contextual terminal to access data on the email/chat application or email/chat service. This data 363 can be clustered and associated to avail the user's expertise and relevance, which are stored in the contextual server 110. Expertise and relevance of other users on the email/chat application or email/chat service 361 can be accessed on the browser or email/chat application as the Contextual terminal can access the contextual information of contacts and non-contacts from the Cloud Server 110. Users 162 can provide and access the data through context terminal on the 361 browser or chat/email application.

FIG. 20 is an illustration of a block diagram 391 showing various functional elements of the computing device 101 to 107 of the system 100 when used as email application/chat application 352 with a plugin 393, in accordance with the disclosed embodiments. Using RESTful APIs, specific data can be availed like a user's contacts and mails in the user's mailbox and/or a user's chat contacts and chat interactions. This data of interactions between users and contacts or non-contacts can be clustered by the specific business attributes of the contact or non-contact leading to a distribution in percentage weights for the specified constituent in each business attribute. As further explained in paragraphs [0091-0095] the bunching of data renders context to avail the user's expertise and relevance The OS (Operating System) 341 of the computing device 101 to 107 can be Android/Windows/ios/Mac.

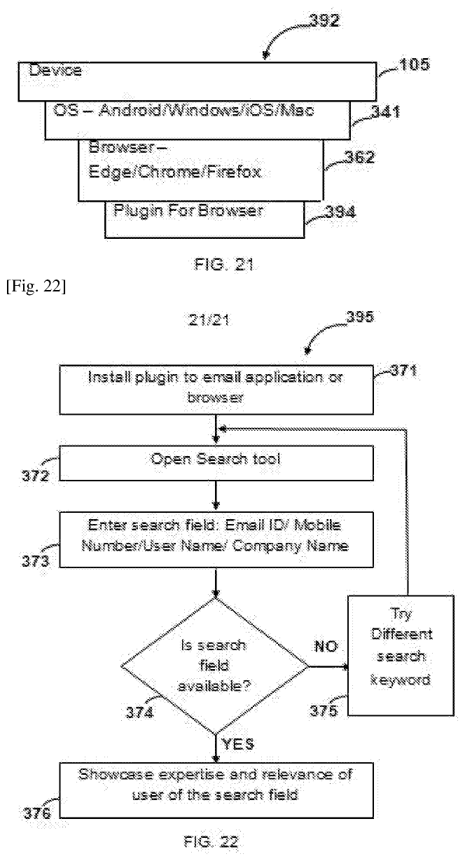

FIG. 21 is an illustration of a block diagram 392 showing various functional elements of the computing device 101 to 107 of the system 100, when used in browser 362 as a browser plugin 394, in accordance with the disclosed embodiments. This is for the browsers 362 for example, Edge, Chrome, Firefox and the like.

FIG. 22 is an illustration of a flow diagram 395 of searching user using Email ID or Mobile number or user name or company name using system 100, in accordance with the disclosed embodiments. As at step 371, the search plugin to email application or browser is installed. Open the search tool on the plugin as at step 372. Searching for a user based on the mobile number/email/Name/Company Name will render the Relevance and Expertise of the user registered or users registered to that specific search term In case of computing device 121, email of each user is associated to the existing tables of industry, domain, function and location and user attributes of designation, company name, website, mobile number, user name. Clicking the plugin, will render a search tab, where the email ID or Mobile number or User's Name or Company Name of a user can be entered as at step 373. The system looks whether the search filed is available or not as at step 374. If the entered keyword is available in the system, the system displays all the relevant results of the users long with expertise and relevance, as at step 376. Else, as at step 375, the system allows the user to enter different search keyword.

TABLE 1

| Attributes | Contact1 | Contact2 | Contact3 | Contact4 | Contact5 |
|---|---|---|---|---|---|
| Mobile# | 9891001234 | 9892001234 | 9893001234 | 9894001234 | 9812398700 |
| Name | Suresh | Mahesh | Ravi | Anita | Sujata |
| Industry | Manufacturing | Wholesale | Retail | Finance | Manufacturing |
| Domain | Carpets | FMCG | Garments | Banking | Garments |
| Function | Sales | Marketing | Operations | Sales | Marketing |
| Location | Kochi | Trivandrum | Chennai | Bangalore | Chennai |
| Company Name | Keratex Industries | Amway | Big Bazaar | HDFC Bank | Lifestyle |
| Designation | GM | Director | Cluster Head | Branch Manager | VP - Brand |
| Website | Keratex.com | Amway.com | Futuregroup.com | Hdfcbank.com | Lifestyle.com |
| Email | suresh@keratex.com | Mahesh@amway.com | ravi@futuregroup.com | anita@hdfcbank.com | sujata@lifestyle.com |

The present Table 1 is created to depict the user's contacts, similarly other tables can be created to depict the user's actual interaction (not just as a stored contact but also interactions such as call made/received, emails sent/received, chats sent/received) with specific contacts for the day or week or month or as the case of time can be considered. Such other table may have contacts repeating in frequency over the time case considered on account of multiple interactions between user and contacts and/or non-contacts, nevertheless these multiple user's interaction can be clustered over specific constituents, for example, manufacturing, wholesale, retail, finance, in the business attribute of “industry” can be availed. The clustering can be arrived at by appropriating a user's interaction with the contact's (and/or non-contact's) business attribute. Aggregating the user interactions over multiple interactions with contact's (and/or non-contact's) business attribute will yield a percentage weight for the specific constituents in that business attribute for example, industry. This can be similarly constructed for the other business attributes of Domain, Location, Organization Scale, and Function considering interactions between the user and contact or non-contact. An actual working of this process has been described with Table 1.

This Table 1 is a table that showcases how user's information is collated for providing contextual information for a User A. Let's say that this User A has only five contacts on his device 121 and these five contacts are as depicted in Table 1. Based on the data of each of these five contacts, we can assess that the User who has these five contacts, has Industry Reach as would be depicted as a Chart in FIG. 13 would be 40% Manufacturing (two of the five contacts are in Manufacturing; 2/5×100=40%), 20% Wholesale, 20% Retail and 20% Finance (As only one contact in each of these industries; 1/5×100=20%). Given that there are only a total of five contacts for User A, the specific Chart would be depicted in the format as shown in Table 1 but would have these values for the “Industries Reach” collated for User.

Similarly based on the five contacts of User A, the “Function Reach” as would be depicted as a Chart in FIG. 13 would be 40% Marketing (two of the five contacts are in Marketing; 2/5×100=40%), 20% Sales, 20% Finance and 20% Operations (As only one contact in each of these functions; 1/5×100=20%).)

The example provided in Table 1 is with five contacts for User A, as the number of contacts who are registered on the contextual system for User A increases, the data would be collated to include a wider tabulation of Industries and Functions aggregated to the appropriate percentage weight. In a similar fashion using the contacts, we would compute the Domain weights and Location weights for the five contacts. The Domain weights and Location weights computed to a percentage weight would be charted as depicted in FIG. 14. Here to, as the number of contacts (who are also registered on the contextual system) for User A increases, the data would be collated to include a wider tabulation of Domains and Locations aggregated to the appropriate percentage weight. FIG. 15 is computed taking the logs whether call/email/chat messages for a certain number of days. These logs represent recent call/email/chat message interactions with the user over a certain specified interval of time. The interaction during this specified period of time with contacts ascribed in the logs as pertaining to the business attribute “Industry” and “Function” are computed and shown as a charts for Industry and Function as depicted in FIG. 15. This specific chart is tabulated from interacted contacts as ascribed by Logs whether call/email/Chat messages and clustered by the specific constituents of business attributes into the charts for Industry and Function FIG. 15. As the time frame ascribed in the logs is widened the data would be collated to include a wider tabulation of Industries and Functions aggregated to the appropriate percentage weight.

Based on FIG. 13 once the top Industry interactions for a User A have been computed, we use the Top Industry and collate how many calls/email/chat messages were outbound (sent) vs inbound (received). This is showcased as show in FIG. 12 as Industry Proximity 297. This Bar Chart 296 in FIG. 12 tabulates the Inbound vs Outbound interactions in the Top five Industries for User A based on the Top Industries distribution for User A. The four cells in FIG. 12 is based on the interactions that the User A makes with contacts. These interactions are computed and displayed with the help of the context collector. The details of user proximity 297 are also shown. FIG. 12, FIG. 13, FIG. 14 and FIG. 15 is one part of the contextual information of User A which can be viewed by the plurality of users in the network and even by non-contacts out of the network via the web URL. These FIG. 12 to FIG. 15 comprise the section “Relevance” and is one part of the contextual information processed for User A by the contextual system.

FIG. 11 is a representation of how user information tabled in Table 1 is showcased using the contextual terminal. The information is solicited from the user, which when the registered users provide is displayed in the manner as shown in FIG. 11. Once a user has installed the contextual terminal on Smartphone/PC, and the information solicited is also provided by each registered user, and this happens over a plurality of users in the network, then this information can be availed by any other user using the contextual terminals. User on providing the information also gets a unique web URL associated specifically to the user. This web URL showcases the information computed in FIG. 12 to FIG. 15 as well as user information as depicted in FIG. 11 and can be showcased to any recipient within and out of the contextual terminal system network. This FIG. 11 comprises the other part of the contextual information for the user and is called “Expertise”. The “Expertise” (FIG. 11) and “Relevance” (FIG. 12 to FIG. 15) together go on to form the contextual information for a User on the Contextual System network. Similar a contextual information (Expertise and Relevance) for a plurality of users is garnered which can be searched, assessed and viewed by any other user on the contextual system network with the contextual terminal installed on the smartphone/PC.

A computer-readable medium at user side, stores instructions executable by one or more processing devices in a computing device 121 having at least one user terminal 151 to perform a method for facilitating at least one contextual information of a user. Further, a computer-readable medium that at server side, stores instructions executable by one or more processing devices in a server 110 to perform a method for facilitating at least one contextual information of a user.

It will be appreciated that variations of the above disclosed and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

Although embodiments of the current disclosure have been described comprehensively in considerable detail to cover the possible aspects, those skilled in the art would recognize that other versions of the disclosure are also possible.

What is claimed is:

1. A system (100) of facilitating at least one contextual information of a user communicated over a unique web address (287), the system comprising:
a plurality of computing devices (121), each computing device comprises at least one user terminal (151) configured to create a profile of the user with at least one business attribute selected at least from any or combination of at least one industry, function, domain, location, designation, company name, website, and organization size using at least one unique identity of the user,
the computing device (121) and/or the user terminal (151) comprises at least one contact data and/or non-contact data having at least a registered user of the user terminal (151) with corresponding profile, wherein the contact data is at least one unique identity of at least one contact and/or at least one non-contact data is at least one unique identity of at least one non-contact in the computing device (121) and/or the user terminal (151), at least one non-contact is selected at least from any or combination of a mobile number and/or an electronic mail identity and/or an electronic user name; and
the user terminal (151) comprises at least one context collector (182) to track and record at least one user interactions between the user and the contact or non-contact using at least one business attribute; and
at least one server (110) comprising at least one database (160) and at least one application programming interface (353), wherein the database (160) comprises at least one business attribute table to store each business attribute with at least one constituent for all users, and the at least one application programming interface (353) is configured to retrieve the contextual information of the user from the at least one server (110) and to render the contextual information in at least one website of the user using at least one application programming interface (353) on at least one third party application,
and wherein the at least one server is configured:
store the profile of each user along with the business attributes,
update the contextual information, on change in at least one of the user interaction, the contact data, or non-contact data of the user;
match and retrieve the profile of each user corresponding contact data and/or non-contact data in the computing device,
cluster common constituents of each business attributes of the contacts and/or non-contacts of that user to from contextual information of each user based on the type of interactions of that user with contacts and/or non-contacts,
generate a distribution in percentage weighs for the clustered constituents in each business attribute; and
store the contextual information of the user in the at least one server (110);
wherein the computing device (121) retrieves the profile of each user and corresponding contact data and/or non-contact data, retrieves the contextual information of the contacts and non-contacts from the server and displays in the user terminal (151).

2. The system of claim 1, wherein the contextual information of the user is formed by clustering common constituents of each business attribute of the contacts and/or non-contacts of that user the contextual information comprises of clustering at least one common constituents for the various business attributes of the contacts and/or non-contacts of that user on the basis of the interaction of the user with contacts and/or non/contacts.

3. (canceled)

4. (canceled)

5. (canceled)

6. (canceled)

7. The system of claim 1, wherein the user terminal (151) retrieves the business attributes from the at least server (110), displays to the user and allows the user to create the profile by entering and for selecting at least one constituent in at least one business attribute.

8. (canceled)

9. (canceled)

10. (canceled)

11. (canceled)

12. The system of claim 1, wherein the contextual information for users are indicated using at least one confidence level representing the accuracy level (262) of the contextual information rendered to the user, the contacts and the non-contacts.

13. (canceled)

14. The system of claim 1, wherein the user terminal (151) is configured to allow the user to search other users using at least one unique identity of the other users registered on the system and/or business attribute and/or at least one constituent.

15. (canceled)

16. (canceled)

17. The system of claim 1, wherein the computing device (121) is configured to display the contextual information as at least one graph based on a distribution of at least one constituent in the business attribute or a combination of two or more business attributes with their corresponding constituents.

18. The system of claim 1, wherein the computing device (121) and/or the user terminal (151) comprises at least one contact data stored with at least one user information in at least one storage device of the computing device.

19. The system of claim 1, wherein the computing device (121) and/or the user terminal (151) comprises at least one non-contact data displayed to the user.

20. The system of claim 1, wherein the user interaction is at least one or combination of storing at least one unique identity of contacts and/or non-contacts, interaction made by user with contacts and/or non-contacts and/or interactions received from contacts and/or non-contacts; where user, contacts and non-contacts each have at least one unique identity.

21. (canceled)

22. A method for facilitating at least one contextual information of a user communicated over a unique web address (287), the method comprising:
configuring at least one computing device (121), each comprising at least one user terminal (151) to create a profile of the user with at least one business attribute selected at least from any or combination of at least one of the industry, function, domain, location, designation, company name, website and organization size using at least one unique identity of the user;
allowing the computing device (121) and/or the user terminal (151) to have at least one contact data comprising at least one unique identity of at least one contact and at least one non-contact data comprising at least one unique identity of at least one non-contact selected at least from any or combination of a mobile number and/or electronic mail identity and/or an electronic user name:
configuring at least one at least one context collector (182) to track and record at least one user interactions between the user and the contact or non-contact using at least one business attribute;
configuring at least one server (110) comprising at least one database (160) and at least one application programming interface (353); wherein the database (160) comprises at least one business attribute to store each business attribute with at least one constituent for all users and the at least one application programming interface (353) is configured to retrieve the contextual information of the user from the at least one server (110) and to render the contextual information in at least one website of the user using at least one application programming interface (353) on at least one third party applications,
and wherein the at least one server is configured to:
store the profile of each user along with the business attributes,
update the contextual information, on change in at least one of the user interaction, the contact data, or non-contact data of the user;
match and retrieve the profile of each user corresponding to the contact data and/or non-contact data in the computing device;
form contextual information of each user by clustering common constituents of each business attributes of the contacts and/or non-contacts of that user based on the type of interactions of that user with contacts and/or non-contacts;
generate a distribution in percentage weights for the clustered common constituents in each business attribute; and
store the contextual information of the user in the database; and
configuring the computing device (121) to retrieve the profile of each user and corresponding contact data and/or non-contact data, and to retrieve the contextual information of the contacts and non-contacts from the at least one server and display in the user terminal (151).

23. The method of claim 22, wherein the contextual information of the user is formed by clustering common constituents of each business attribute of the contacts and/or non-contacts of that user, the contextual information comprises of clustering at least one common constituent for the various business attributes of the contacts and/or non-contacts of that user on the basis of the interaction of the user with contacts and/or non-contacts.

24. (canceled)

25. (canceled)

26. (canceled)

27. The method of claim 22, wherein the profile of each user with business attribute is created by selected or entering the constituents for each business attributes retrieved from the at least one server (110).

28. The method of claim 22 further comprising: allowing the user, the contact or the non-contact to use at least one of mobile number, electronic mail identity or electronic user name, as unique identity.

29. (canceled)

30. The method of claim 22, further comprising: indicating the contextual information of the users using at least one confidence level and representing the confidence level as accuracy level (262) of the contextual information rendered to the user, the contacts and the non-contacts.

31. (canceled)

32. The method of claim 22, further comprising: configuring the user terminal (151) to allow the user to search other users using at least one business attribute and/or unique identity of the users, contacts and non-contacts.

33. (canceled)

34. The method of claim 22, further comprising: configuring the computing device (121) to display the contextual information as at least one graph based on the distribution of at least one constituent in the business attribute or a combination of two or more business attributes with their corresponding constituents.

35. The method of claim 22, further comprising: allowing the computing device (121) and/or the user terminal to store at least one contact data with at least one user information.

36. The method of claim 22, further comprising: allowing the computing device (121) and/or the user terminal to display at least one non-contact data to user.

37. (canceled)

38. A computer-readable medium that stores instructions executable by one or more processing devices in, a computing device (121) having at least one user terminal (151) to perform a method for facilitating at least one contextual information of a user communicated over a unique web address (287), the computer-readable medium comprising:
configuring at least one computing device (121), each comprising at least one user terminal (151) to create a profile of the user with at least one business attribute selected at least from any combination of at least one of industry, function, domain, location, designation, company name, website and organization size using at least one unique identity of the user;
allowing the computing device (121) and/or the user terminal (151) to have at least one contact data comprising at least one unique identity of at least one contact and at least one non-contact data comprising at least one unique identity of at least one non-contact selected at least from any or combination of a mobile number and/or an electronic mail identity and/or electronic user name;
configuring at least one at least one context collector (182) to track and record at least one user interactions between the user and the contact or non-contact using at least one business attribute; and
configuring the computing device (121) to retrieve the contextual information of the contacts and non-contacts from the at least one server and display in the user terminal (151)
the at least one server (110) comprising at least one database (160) and at least one application programming interface (353)), wherein the database (160) comprises at least one business attribute table to store each business attribute with at least on constituent for all users and the at least one application programming interface (353) is configured to retrieve the contextual information of the user from the at least one server (110) and to render the contextual information in at least one website of the user using at least one application programming interface (35) on at least one third party applications.

39. The computer computer-readable medium of claim 38, further comprising:
storing the profile of user along with at least one business attribute with at least one constituent for all users;
updating the contextual information, on change in at least one of the user interaction, contact data, or non-contact data of the user
matching and retrieving the profile of each user and corresponding contact data and/or non-contact data of the user in the computing device;
forming contextual information of each user by clustering common constituents of each business attributes of the contacts and/or non-contacts of that user based on the type of interactions of that user with contacts and non-contacts;
updating the contextual information on change at least one of the user interactions the contact data or non-contact changes;
generating a distribution in percentage weights for the clustered common constituents in each business attributes; and
storing the contextual information of the user in a database (160).
